(19) United States
(12) Patent Application Publication
(10) Pub. No.: US 2013/0094403 A1
(43) Pub. Date: Apr. 18, 2013

(54) METHOD AND APPARATUS FOR PROVIDING SENSOR NETWORK INFORMATION

(71) Applicant: Electronics and Telecommunications Research In, Daejeon (KR)

(72) Inventors: Dong-Hwan PARK, Daejeon (KR); Hyochan BANG, Daejeon (KR); Mal-hee KIM, Daejeon (KR); Sun-Jin KIM, Daejeon (KR); Yoon Sik YOO, Daejeon (KR); Byung Bog LEE, Daejeon (KR); Cheol Sig PYO, Daejeon (KR)

(73) Assignee: ELECTRONICS AND TELECOMMUNICATIONS RESEARCH INSTITUTE, Daejeon (KR)

(21) Appl. No.: 13/653,888

(22) Filed: Oct. 17, 2012

(30) Foreign Application Priority Data
Oct. 18, 2011 (KR) 10-2011-0106543
Oct. 9, 2012 (KR) 10-2012-0112035

(51) Int. Cl. H04W 84/18

(52) U.S. Cl. 370/255

(57) ABSTRACT

An apparatus for providing sensor network information receives sensing information containing sensing values obtained by sensor resources from sensor network middleware, converts the sensing information into an RDF (resource description framework) form, and stores and manages it in an RDF storage. The apparatus searches for information corresponding to a query from an application service, from among the information stored in the RDF storage, and provides it to the application service.

### CROSS-REFERENCE TO RELATED APPLICATION

This application claims priority to and the benefit of Korean Patent Application Nos. 10-2011-0106543 and 10-2012-0112035 filed in the Korean Intellectual Property Office on Oct. 18, 2011 and Oct. 9, 2012, the entire contents of which are incorporated herein by reference.

### BACKGROUND OF THE INVENTION

(a) Field of the Invention

The present invention relates to a method and apparatus for providing information about a sensor network.

(b) Description of the Related Art

For a service using a sensor network or ubiquitous sensor network (USN), in general, data is collected from a sensor and analyzed, and processed into useful information for the service. Only experts in this field or some expert developers are able to know the meaning of unprocessed data and its values which can be obtained from a sensor or sensor network.

If the sensor network or USN technology becomes widespread and popular in the future, USN infrastructure will be easily accessed from surrounding areas and services using USN will be available. However, unprocessed sensor data and its sensing values, which can be obtained from a sensor or sensor network, are managed in separate, different ways of data representation. Therefore, it is difficult for many different services to jointly use and analyze such sensor data and sensing values. Moreover, conventional sensor networks and USN services have been developed, built, and managed exclusively for its services. Therefore, there is no standard method of data representation or no open API (application program interface), so various services are not able to jointly use sensing data or sensing values. In addition, although unprocessed data and sensing values can be obtained from a sensor network and USN by using USN middleware that supports connections between different types of sensor networks, the USN middleware does not provide various semantic information that the data and sensing values of the sensor network and USN resources have.

Accordingly, it is difficult to deduce common semantic information regarding various information provided from different types of sensor networks, and each service has to search for sensor resources, deduce information, and extract semantic information individually, thus making service development complicated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus which process various types of data obtained from a sensor network into standardized semantic information and provide it. Furthermore, the present invention has been made in an effort to provide a method and apparatus which provide semantic USN information corresponding to a service request from service equipment.

An embodiment of the present invention provides a method for providing sensor network information in an apparatus connected to sensor network middleware. The method includes receiving sensing information containing sensing values obtained by sensor resources from the sensor network middleware; converting the sensing information into an RDF (resource description framework) format and storing the same in an RDF storage; analyzing a query provided from an application service; and searching for information corresponding to the query, among the information stored in the RDF storage, based on the analysis result, and providing the same to the application service.

The method may further include performing deduction based on the sensing information in the RDF format stored in the RDF storage.

Here, in the providing of information to the application service, if the query is a semantic information query, a query result, which contains sensor resource metadata, sensing values, and deduced semantic information, may be provided to the application service, based on the information in the RDF format stored in the storage.

The method may further include storing the sensing information received from the sensor network middleware in a sensing information storage; and if the query is a non-real-time sensing value information query based on the analysis result, providing the sensing information stored in the sensing information storage to the application service.

Here, the providing of the sensing information stored in the sensing information storage to the application service may include if the non-real-time sensing value information query is a one-time sensing information query, immediately providing the sensing information to the application service; and if the non-real-time sensing value information query is an event sensing information query or a periodic sensing information query, providing the sensing information to the application service based on a pre-stored push service transmission address.

The method may further include if the query is a real-time sensing value information query based on the analysis result, generating a middleware query corresponding to the query and transmitting the same to the sensor network middleware; obtaining sensing information containing sensing values corresponding to the middleware query from the sensor network middleware; and providing the obtained sensing information to the application.

The method may further include if it is determined that the creation of a sensor community is required, based on the analysis result, creating a new sensor community based on the information stored in the RDF storage.

Also, the method may further include receiving a request for ID allocation to the sensor resources from the sensor network middleware; allocating IDs and URLs (uniform resource locators) to the sensor resources and transmitting the allocated information to the sensor network middleware; receiving middleware connection information and sensor resource operating state information from the sensor network middleware; and converting the allocated information, the connection information, and the operating state information into RDF, and storing and managing the same in the RDF storage.

Another embodiment of the present invention provides an apparatus which is connected to sensor network middleware and providing sensor network information. The apparatus includes a middleware interface processor that interfaces with the sensor network middleware; a middleware query processor that receives sensing information containing sensing values obtained by sensor resources from the sensor network middleware; an RDF converter that converts the sensing information into an RDF (resource description framework) form; a storage that stores the sensing information in the RDF format; a query analyzer that analyzes a query provided from an application service; and a query processor that searches for information corresponding to the query, among the information stored in the RDF storage, based on the analysis result, and provides the same to the application service.

The apparatus may further include a sensing information storage that stores the sensing information received from the sensor network middleware without RDF conversion.

Here, the query analyzer may include a first query generator that, if the query is a semantic information query, generates a SPARQL (semantic protocol and RDF query language) query and transmits the same to the query processor; a second query generator that, if the query is a non-real-time sensing value query, generates a query corresponding to the format of the sensing information storage, and transmits the same to the sensing information storage unit; a third query generator that, if the query is a real-time sensing value query, generates a middleware query corresponding to the sensor network middleware; and a fourth query generator that, if the query is a community- related query, generates a community sensing value query request if it is determined that a continuous query for sensing values for a specific sensor community is required, based on the analysis result.

The apparatus may further include a middleware query processor that transmits the middleware query to the sensor network middleware involved through the middleware interface processor, receives response values from the sensor network middleware in response to the middleware query, and provides the same to the query analyzer, provides the same in the sensing information storage unit, or provides the same to the RDF converter.

The apparatus may further include a community manager that generates a new sensor community based on the information stored in the RDF storage if it is determined that the creation of a sensor community is required, based on the analysis result.

Here, for a semantic information query, the query analyzer may provide a query result, which contains sensor resource metadata, sensing values, and deduced semantic information, to the application service, based on the information in the RDF format stored in the RDF storage.

The apparatus may further include a semantic deduction unit that performs deduction based on the sensing information in the RDF format stored in the RDF storage, and stores semantic information corresponding to the deduction result in the RDF storage.

The apparatus may further include a push service unit that, if the non-real-time sensing value information query is an event sensing information query or periodic sensing information query, provides the sensing information to the application service based on a pre-stored push service transmission address.

The apparatus may further include an IP manager that allocates IDs and URLs (uniform resource locators) to the sensor resources in response to an ID allocation request from the sensor network middleware, and converts the allocated information into RDF format by the RDF converter and stores and manages the same in the RDF storage; and a catalogue service unit that receives middleware connection information and sensor resource operating state information from the sensor network middleware, and converts the allocated information, the connection information, and the operating state information into RDF, and stores and manages the same in the RDF storage.

### BRIEF DESCRIPTION OF THE DRAWINGS

FIG. 1 is a view showing a structure of an apparatus for providing sensor network information according to an exemplary embodiment of the present invention.

FIG. 2 is a view showing a structure of a query analyzer according to an exemplary embodiment of the present invention.

FIG. 3 is a view showing a structure of an RDF converter according to an exemplary embodiment of the present invention.

FIG. 4 is a flowchart showing the process of registration of a USN resource in a method for providing sensor network information according to an exemplary embodiment of the present invention, and FIG. 5 is a view showing the relationship between the components for the process of registration of a USN resource.

FIG. 6 is a flowchart showing the process of inquiring for information about USN resources in the method for providing sensor network information according to an exemplary embodiment of the present invention, and FIG. 7 is a view showing the relationship between the components for the process of inquiring for USN information.

FIG. 8 is a flowchart showing the process of unidirectional sensing value reporting and transmission in the method for providing sensor network information according to an exemplary embodiment of the present invention, and

FIG. 9 is a view showing the relationship between the components for the process of reporting and transmitting sensing values.

FIG. 10 is a view showing the relationship between the components for the process of processing a non-real-time sensing value query in the method for providing sensor network information according to an exemplary embodiment of the present invention.

FIG. 11 is a flowchart showing the process of processing a real-time sensing value information query in the method for providing sensor network information according to an exemplary embodiment of the present invention, and

FIG. 12 is a view showing the relationship between the components for the process of processing a real-time sensing value information query.

FIG. 13 is a flowchart showing the process of semantic USN deduction in the method for providing sensor network information according to an exemplary embodiment of the present invention, and FIG. 14 is a view showing the relationship between the components for the process of semantic USN deduction.

FIG. 15 is a view showing the relationship between the components for the process of creating and managing a USN community in the method for providing sensor network information according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Hereinafter, a method and apparatus for providing sensor network information according to an exemplary embodiment of the present invention will be described with reference to the drawings.

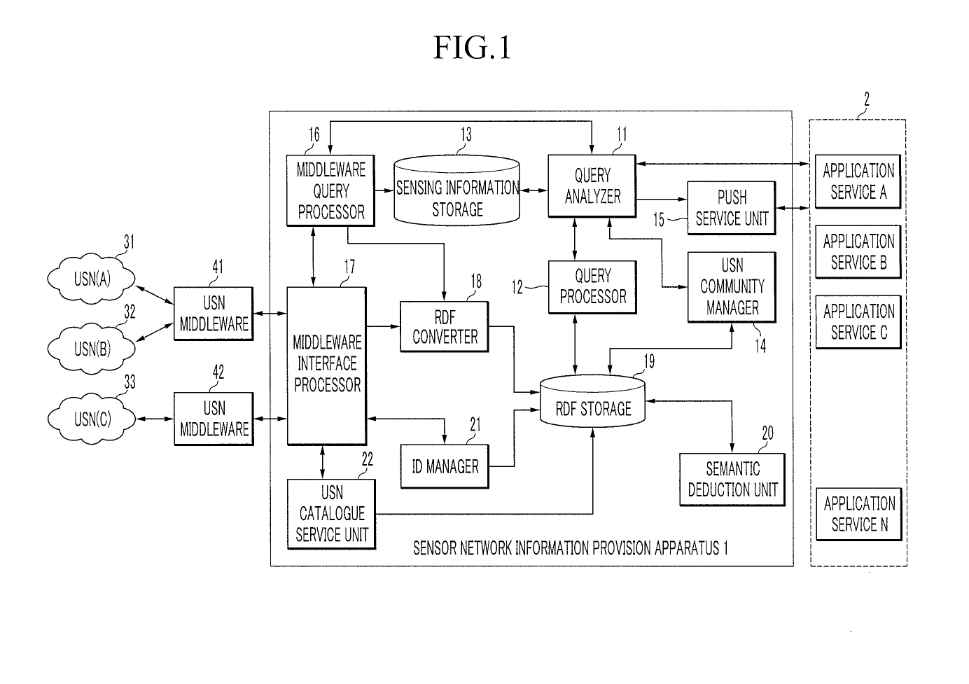

FIG. 1 is a view showing a structure of an apparatus for providing sensor network information according to an exemplary embodiment of the present invention.

As shown in FIG. 1, the sensor network information provision apparatus according to the exemplary embodiment of the present invention communicates with service equipment 2 that provides different application services, and communicates with USN middleware 41 and 42 that are connected with a plurality of sensor networks (for example, but not limited to, USNs (ubiquitous sensor networks) 31, 32, and 33). The sensor network information provision apparatus 1 processes data obtained from the USN middleware 41 and 42 and stores it, and responds to a service request from the service equipment 2 by using a semantic technique.

The service equipment 2 is equipment that provides services (application service A, application service B, etc.), for example, a variety of services such as an environment monitoring service, a personal health care service, a remote energy management service, and so on, based on information collected through the USNs 31, 32, and 33. The service equipment 2 receives information about sensor resources, such as metadata about USN resources and sensing values of the USN resources, through the sensor network information provision apparatus 1 according to an exemplary embodiment of the present invention. The service equipment 2 may designate a certain sensor or USN and request a sensing value therefrom if it wants a real-time sensing value. If there is no information about a desired USN, the service equipment 2 may obtain related information from the sensor network provision apparatus 1 by various search requests, such as a keyword search and a location-based search.

For example, in the case of an environment monitoring service, if it is desired to get environmental information of surrounding areas within 10 km based on user location information, the service equipment 2 may request a list of environmental sensors existing within 10 km radius from the current user location. That is, the service equipment 2 requests the sensor network information provision apparatus 1 to supply environmental information sensing values and status information of the entire list of environmental sensors or of some selected sensors, and processes the sensing values and status information and displays them in a method appropriate for a service UI (user interface), as a response to the request.

The USNs 31, 32, and 33 include a plurality of USN resources. The USN resources include at least either of one sensor node or one actuator node, or a sensor group consisting of a plurality of sensor nodes, or an actuator group consisting of a plurality of actuator nodes.

The USN middleware 41 and 42 is situated between the USNs and the sensor network information provision apparatus 1, and provides information from the USNs to the sensor network information provision apparatus 1 and transmits a command from the sensor network information provision apparatus 1 to the USN involved. Further, the USN middleware 41 and 42 stores and manages metadata about the USN resources.

As shown in FIG. 1, the sensor network information provision apparatus 1 includes a query analyzer 11, a query processor 12, a sensing information storage 13, a USN community manager 14, a push service unit 15, a middleware query processor 16, a middleware interface processor 17, an RDF (resource description framework) converter 18, an RDF storage 19, a semantic deduction unit 20, an ID manager 21, and a USN catalogue service unit 22.

The query analyzer 11 analyzes a query requested by the service equipment 2, and requests the query processor 12 for related information based on the analysis result. Specifically, the query analyzer 11 classifies the query requested by the service equipment 2 into a semantic USN information query, a non-real-time sensing value query, a real-time sensing value query, and a USN community-related query. Based on a classification result, the query analyzer 11 transmits the semantic USN information query and the non-real-time sensing value query to the sensing information storage 13 and sends a related information request, transmits the real-time sensing value query to the middleware query processor 12 and sends a related information request, and transmits the USN community-related query to the USN community manager 14 and sends a related information request. The query analyzer 11 may send a proper number of query requests to a plurality of USN middleware in order to inquire for sensing values of a community selected or created by the USN community manager 14.

The query analyzer 11 responds with USN resource information (including metadata), sensing values, and deduced semantic information stored in the RDF storage 19, in response to the semantic USN information query. The non-real-time sensing value query indicates that the user or service equipment does not make a request for real-time sensing values. Thus, the query analyzer 11 responds with a sensing value corresponding to a request, among the sensing values stored in the sensing information storage 13 (sensing values transmitted to and stored in the sensor network information provision apparatus 1 according to a previous query or by a sensor of a push type). The middleware real-time sensing value query indicates that sensing values at the current time are requested in real time. The query analyzer 11 responds with the latest sensing values obtained after the current time through USN middleware. In response to the USN community-related query, the query analyzer 11 responds with information relating to the USN community involved.

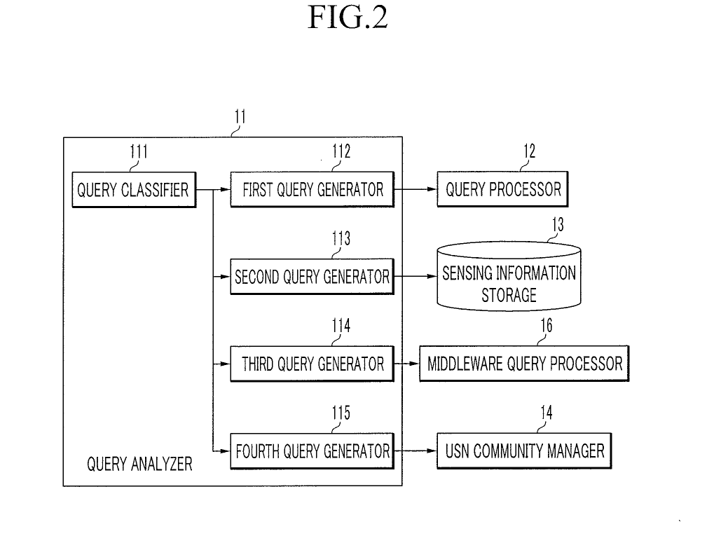

FIG. 2 is a view showing a detailed structure of the query analyzer 11.

As shown in FIG. 2, the query analyzer 11 includes a query classifier 111, a first query generator 112, a second query generator 113, a third query generator 114, and a fourth query generator 115.

The query classifier 111 classifies a query (hereinafter referred to as an input query) provided from the service equipment 2 as one of the above-described four queries.

If the input query from the service equipment 2 is a semantic USN information query, the first query generator 112 generates a SPARQL (semantic protocol and RDF query language) query for the input query and transmits it to the query processor 12. The SPARQL is a semantic web standard query language, a W3C standard. The first query generator 112 includes information on the ontology schema of the USN resources and USN communities (referred to as sensor communities) in the RDF storage unit 19, which is required to generate a SPARQL query. The first query generator 112 may be referred to as a “SPARQL query generator”.

If the input query from the service equipment 2 is a non-real-time sensing value query, the second query generator 113 generates a SQL (structured query language)/native API query corresponding for the input query, and inquires into the sensing information storage 14 based on the generated query. If the sensing information storage 13 is an RDB (relational DB), the second query generator 113 generates an SQL query for the input query. If the sensing information storage 13 is a NoSQL DB, the second query generator 113 generates a native API query for this DB corresponding to the input query. The second query generator 113 may be referred to as a “SQL/native API query generator”.

If the input query from the service equipment 2 is a real-time sensing value query, the third query generator 114 generates a query according to API provided from USN middleware. The third query generator 114 may be referred to as a “USN middleware query generator”.

If the input query from the service equipment 2 is a USN community-related query, the fourth query generator 115 generates a USN community sensing value query if it is determined that a continuous query for sensing values for a specific sensor community is required, based on the analysis result.

The fourth query generator 115 inquires of the USN community manager 14 if there is a USN community corresponding to the input query, and if not, may request generating of a USN community corresponding to the analysis result. The fourth query generator 115 may be referred to as a “USN community manager query generator”.

The query processor 12 processes a query (particularly, a SPARQL query) provided from the query analyzer 11, and inquires for the USN resource information (including metadata), sensing values, and deduced semantic information that are stored in the RDF storage 19, in response to the semantic USN information query. The query processor 12 may simultaneously process a plurality of SPARQL queries. It searches for a triple in the RDF storage 19, creates a response to the query, and provides it to the query analyzer 11.

The sensing information storage 13 stores information about sensing values transmitted to the sensor network information provision apparatus 1 by a previous query request or by a sensor having a push characteristic. It responds with a corresponding sensing value in response to an SQL/native API query corresponding to the non-real-time sensing value query provided from the query analyzer 11.

The USN community manager 14 responds with corresponding USN community-related information in response to an information request of a USN community-related query. A USN community refers to a logical sensor network which is configured based on USN resources required to perform a predetermined service.

In response to a USN community-related request transmitted from the query processor 12, the USN community manager 14 requests RDF storage 19 to provide related information to determine whether a community can be configured based on the USN resources (sensors, etc.) corresponding to a requested USN community, whether a certain USN resource already belongs to another community, and so on. Based on a response to the request, the USN community manager 14 responds to the query analyzer 11 with information about the presence of an available USN community and information about the USN community.

If there is no available USN community, a new USN community is created.

The USN community manager 14 creates a USN community by a request from the service equipment 2 or the user, and manages a list of USN resources (sensors, sensor nodes, actuator nodes, etc.) belonging to the created community. Moreover, it generates, maintains, and manages information such as the purpose of creation, creator, control rights, etc. of a USN community. The USN community has a life cycle depending on service continuity after creation, and the USN community manager 14 manages the life cycle of each USN community. The USN community can perform various operations and functions, such as a periodic query for sensing values of sensors in the sensor network, extraction of average sensing values, and control of an actuator when an event occurs according to purpose.

The push service unit 15 provides, to the service equipment 2, such information for which an immediate response cannot be made upon a request, by using a push method. The push service unit 15 transmits an asynchronous information response message in response to requests, such as a periodic query for sensing values, an event query, and a request for status recognition/deduction information, to which an immediate response cannot be made. The service equipment 2 may register a destination address of the asynchronous response message when making a query request. The push service unit 15 transmits a message containing related information to the destination address provided by the service equipment 2 in accordance with a prescribed protocol. The push service unit 15 may be referred to as a push service engine.

The middleware query processor 16 responds with information containing sensing values transmitted from the USN middleware 41 and 42 through the middleware interface 17 in response to a query (for example, a real-time sensing value query) transmitted from the query analyzer 11.

The middleware query processor 16 generates a query to be sent to the USN middleware 41 and 42, i.e., a middleware query, based on the query transmitted from the query analyzer 11, and transmits it to the USN middleware 41 and 42 through the middleware interface processor 17. The middleware query processor 16 performs query state management and periodic sensing value transmission for each of the plurality of middleware. Moreover, the sensing values received from the USN middleware 41 and 42 are stored in the sensing information storage 13 so that they can be used or referred to for other services.

The types of queries provided to the USN middleware include a one-time query, a continuous query, and an event query. The one-time query indicates a query that requests the USN middleware for a sensing value once. This query is terminated upon reception of a response to the query and transmission of sensing values to the application service. The continuous query indicates that continuous requests for sensing values are made for a predetermined period of time in accordance with a cycle requested by the application service. The middleware query processor 16 transmits the continuous query to the USN middleware and makes periodic sensing value reports based on the sensing values periodically obtained in response to the continuous query. The periodic sensing values are transmitted to the service equipment through the push service unit 15. The event query is a query that transmits a sensing value to the application service when an event is detected by an operation for the sensing value. In this case, the query analyzer 11 performs a predetermined operation based on a sensing value transmitted from the middleware query processor 16, and when an event occurs, such as when the result of the operation satisfies a preset condition, transmits the sensing value to the service equipment 2 through the push service unit 15. At this point, the operation for the sensing value may be performed by the middleware query processor 16. Upon completion of the transmission of a response to the query through the push service unit 15, the query is terminated.

The middleware query processor 16 performs control and message management regarding unidirectional sensing value reporting. The unidirectional sensing value reporting indicates that the USN resources report sensing values after performing sensing every predetermined cycle. The USN middleware receives a sensing value report message and transmits it to the sensor network information provision apparatus 1. The middleware query processor 16 receives the unidirectional sensing value report message through the middleware interface processor 17, stores information contained in the unidirectional sensing value report message in the sensing information storage 13, and passes the information to the RDF converter 18.

The middleware interface processor 17 interfaces with the USN middleware 41 and 42, and has two functions of protocol processing and message processing. The middleware interface processor 17 may be configured and mounted as a module according to the standards of communication and messaging with the USN middleware.

The RDF converter 18 converts information passed from the USN middleware 41 and 42 to the sensor network information provision apparatus 1 into RDF, and stores the converted information in the RDF storage 19. USN information, such as metadata about the USN resources and sensing values of the USN resources, which are passed from the USN middleware USN, passes through the RDF converter 18 and is stored in the RDF storage 19.

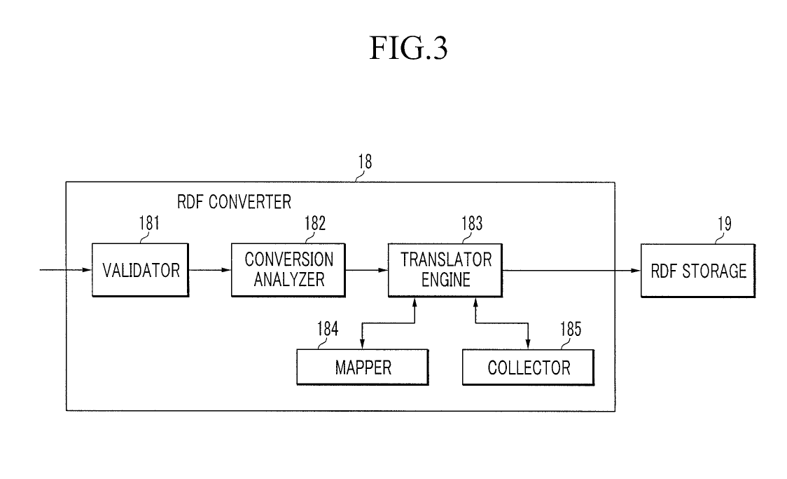

FIG. 3 is a view showing a structure of an RDF converter according to an exemplary embodiment of the present invention.

As shown in FIG. 3, the RDF converter 18 includes a validator 181, a conversion analyzer 182, and a translator engine 183. The RDF converter 18 further includes a mapper 184 storing mapping rules and a collector 185 storing collection rules.

The validator 181 performs validation of USN information, such as metadata about input USN resources and sensing values of the USN resources. Particularly, it validates the format of a document or file, which is input information.

The conversion analyzer 182 performs the analysis of the document or file, which is pre-conversion information.

The translator engine 183 converts information into RDF information based on the analysis result. At this point, it performs translation based on the rule of conversion of structured information, such as XML or legacy DB, into RDF.

The RDF storage 19 stores the RDF information provided from the RDF converter 18. Accordingly, the USN information, such as metadata about USN resources and sensing values of the USN resources, is processed, stored, and managed in the RDF format.

The semantic deduction unit 20 is an engine that deduces a specific status modeled on the ontology stored in RDF. It extracts an event for status deduction based on real-time sensor information, and deduces a status from the event. The deduced information is updated and stored in the RDF storage 19, and may be used for other services.

The ID manager 21 manages the IDs and URLs (uniform resource locators) of USN resources, and maps and manages the addresses and IDs of USN resources to be used by the sensor network information provision apparatus 1 and the USN middleware. When a USN resource is connected to a network, such as the Internet, the ID and address of the USN resource may be automatically registered in the ID manager 21 of the sensor network information provision apparatus 1. The ID manager 21 helps the service equipment 2 to obtain and use information about USN resources.

The USN catalogue service unit 22 helps a USN resource to actively register its state information and connection information, and helps the USN middleware and the sensor network information provision apparatus 1 to use the registered information and perform the support of USN resource connection state and mobility.

The ID manager 21 and the USN catalogue service unit 22 supports the plug and play function to allow a USN resource to be automatically connected to the sensor network information provision apparatus 1 and to register its state and attribute information (ID, connection information, etc.), thereby enabling the sensor network information provision apparatus 1 to dynamically use the registered information.

Next, a method for providing sensor network information according to an exemplary embodiment of the present invention will be described based on the sensor network information provision apparatus having the above-described structure.

First, a semantic registration process for a USN resource will be described.

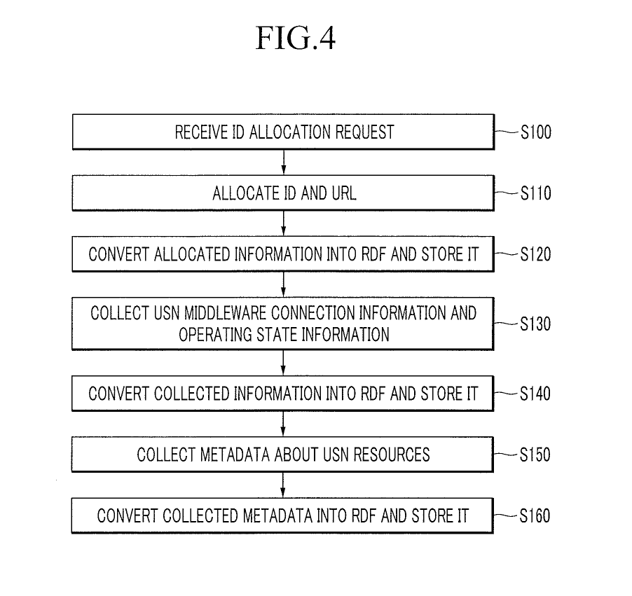

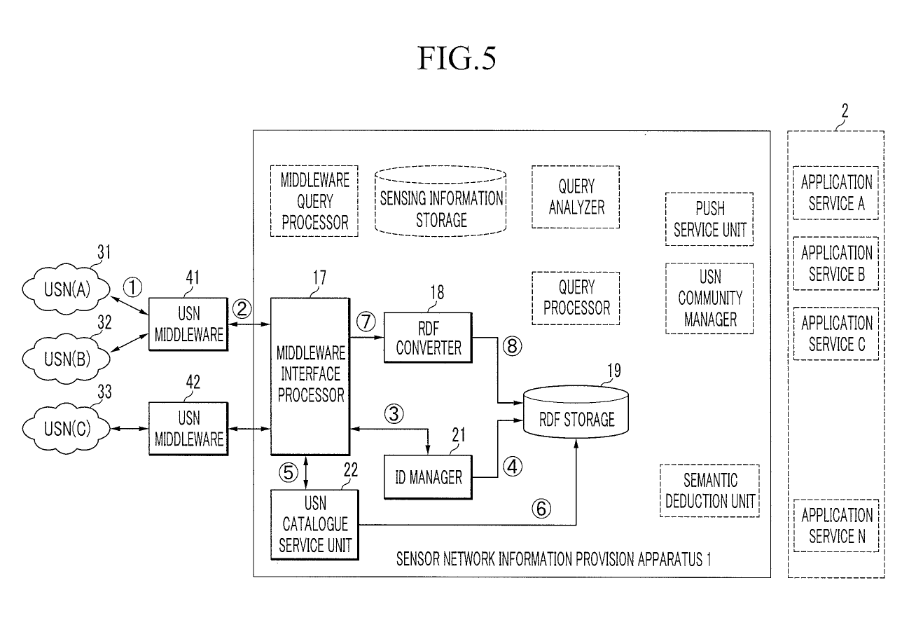

FIG. 4 is a flowchart showing the process of registration of a USN resource in a method for providing sensor network information according to an exemplary embodiment of the present invention, and FIG. 5 is a view showing the relationship between the components for the process of registration of a USN resource.

As shown in FIG. 4, a USN resource (e.g., 31) wanting to connect to a network sends a request for its ID allocation to the USN middleware. The USN middleware 41 transmits an ID allocation request to the sensor network information provision apparatus 1 to allocate an ID to the newly-connected USN resource 31. As shown in FIG. 5, the ID allocation request from the USN middleware 41 is received by the middleware interface processor 17 and passed to the ID manager 21 (S100).

The ID manager 21 of the sensor network information provision apparatus 1 allocates an ID and URL to the USN resource 31 in response to the input ID allocation request (S110). As shown in FIG. 5, the ID manager 21 converts information (ID, URL, etc.) allocated to the USN resource 31 into RDF and stores it in the RDF storage 19 (S120).

The middleware interface processor 17 collects middleware connection information (e.g., IP address or port number) and operating state information (sensing type, operability, etc. of the USN resource) regarding the USN resource 31 from the USN resource 31, and passes this information to the USN catalogue service unit 22 (S130). As shown in FIG. 5, the USN catalogue service unit 22 converts the middleware conection information and operating state information of the USN resrouce into RDF and stores these information in the RDF storage 19 (S140).

Moreover, the middlware interface processor 17 collects metadata of the USN resource 31 from the USN middlware 41 and passes it to the RDF converter 18 (S150). The RDF converter 18 converts the metadata information of the USN resource into RDF and stores it in the RDF storage 19 (S160).

Through the above-described process of registration, the USN resource is registered in the sensor network information provision apapratus 1, and thereafter information is provided based on registered USN resources.

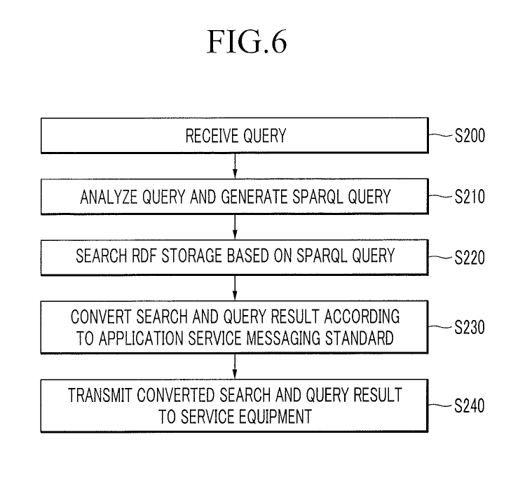

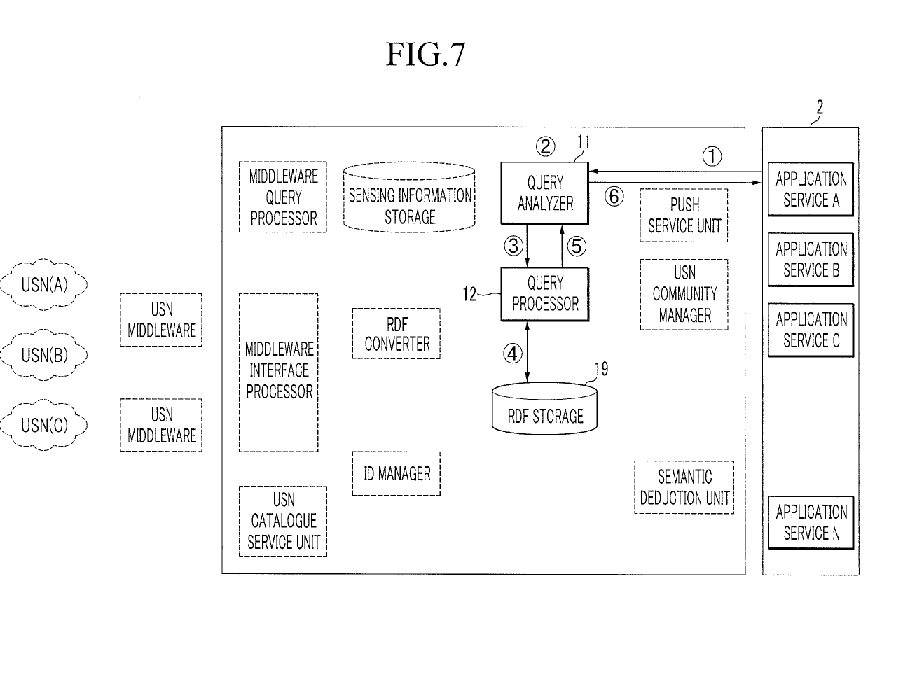

FIG. 6 is a flowchart showing the process of inquiring for information about USN resources in the method for providing sensor network information according to an exemplary embodiment of the present invention, and FIG. 7 is a view showing the relationship between the components for the process of inquiring for USN information.

When a query occurs in an application service, the service equipment 2 transmits the query to the sensor network information provision apparatus 1, as shown in FIG. 6 (S200). The query analyzer 11 of the sensor network information provision apparatus 1 analyzes the input query, and as shown in FIG. 7, passes the query (e.g., semantic USN information query) to the query processor 12 according to the analysis result. The query processor 12 processes the input query and generates a SPARQL query (S210).

The query processor 12 transmits the generated SPARQL query to the RDF storage 19 and searches for RDF information about the USN resource involved (S220). A search and query result (e.g., USN resource metadata, sensing values, deduced semantic information, etc.) is transmitted to the query analyzer 11. Then, as shown in FIG. 7, the query analyzer 11 converts the query result according to the standards of messaging with the application service involved and transmits them to the service equipment 2 (S230 and S240).

Through the process of inquiring for information about a USN resource, metadata, sensing values, deduced semantic information, etc. about the USN resource stored in the RDF format can be transmitted to the application service.

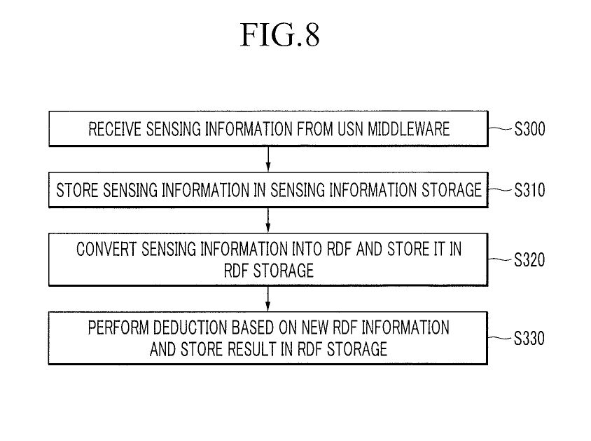

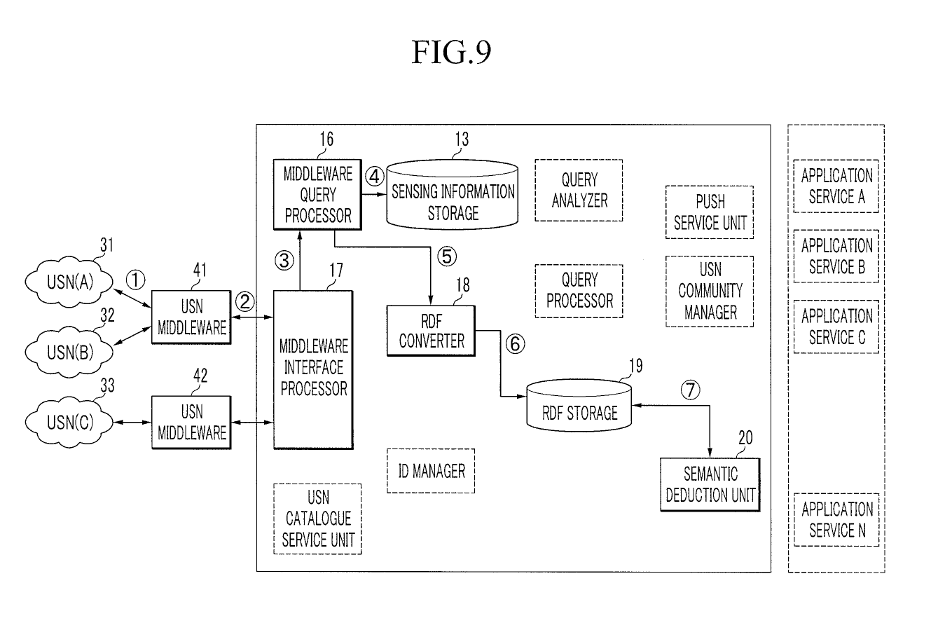

FIG. 8 is a flowchart showing the process of unidirectional sensing value reporting and transmission in the method for providing sensor network information according to an exemplary embodiment of the present invention, and FIG. 9 is a view showing the relationship between the components for the process of reporting and transmitting sensing values.

A USN resource (e.g., 31) collects sensing information every predetermined cycle, and transmits it to the USN middleware (e.g., 41). The USN middleware 41 passes the sensing information (including sensing values) about the USN resrouce to the middleware interface processor 17 of the sensor network information provision apparatus 1.

As shown in FIG. 8, when sensing information about a USN resource is input from the USN middleware, the middleware interface processor 17 transmits sensing information to the middleware query procesor 16, as shown in FIG. 9 (S300). The middleware query processor 16 stores the sensing information in the sensing information storage unit 13 (S310). Also, as shown in FIG. 9, the middleware query processor 16 passes the sensing information to the RDF converter 18, and the RDF converter 18 converts the sensing information into RDF and stores it in the RDF storage 19 (S320).

As new sensing information is stored in the RDF storage 19, the semantic deduction unit 20 performs deduction based on newly added (or modified) information, and stores semantic information corresponding to the deduction result in the RDF storage 19 (S330). The deduced semantic information may be sent as a response to the application service involved upon making a USN resource information query later.

A non-real-time sensing value information query can be processed based on the sensing information stored as described above.

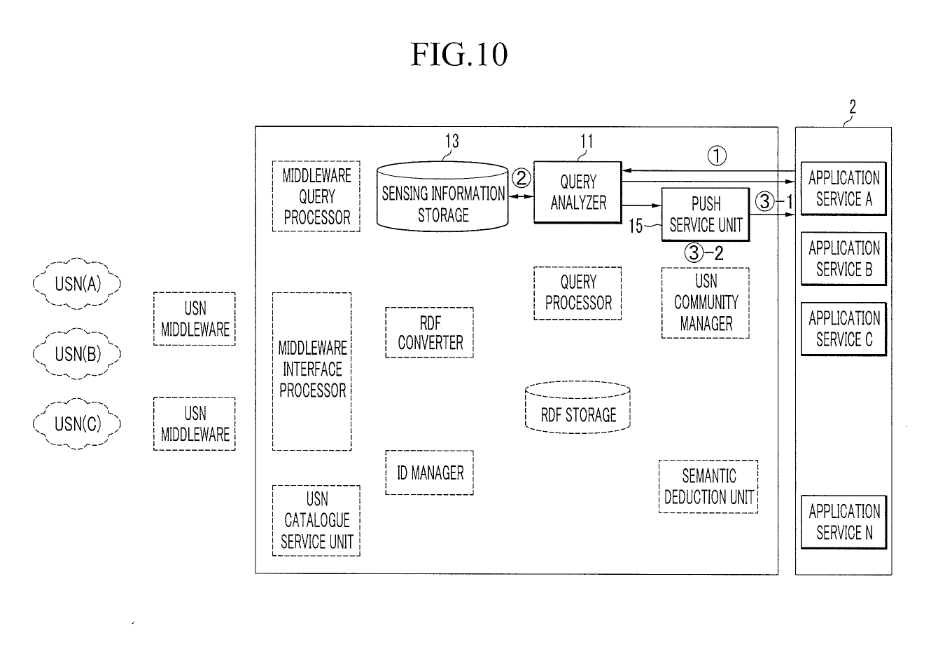

FIG. 10 is a view showing the relationship between the components for the process of processing a non-real-time sensing value query in the method for providing sensor network information according to an exemplary embodiment of the present invention.

As shown in FIG. 10, if an input query from the service equipment 2 is a non-real-time information query as a result of analysis by the query analyzer 11, the query analyzer 11 inquires into the sensing information storage 13 and obtains sensing information about the USN resource involved. If the non-real-time sensing value information query is a one-time senisng information query, obtained sensing information (including sensing values) is immediately transmitted to the service equipment 2.

On the other hand, if the non-real-time sensing information query is a periodic sensing information query or event sensing information query, the sensing information is transmitted through the push service unit 15. In this case, the push service unit 15 pushes the sensing information according to a set cycle, or pushes the sensing information to the service equipment 2 if a predetermined event is satisfied.

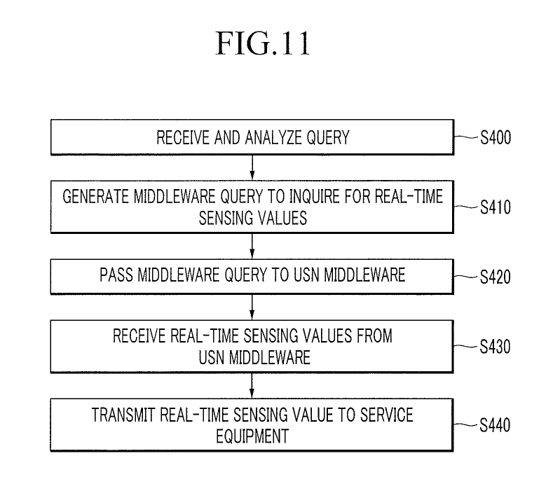

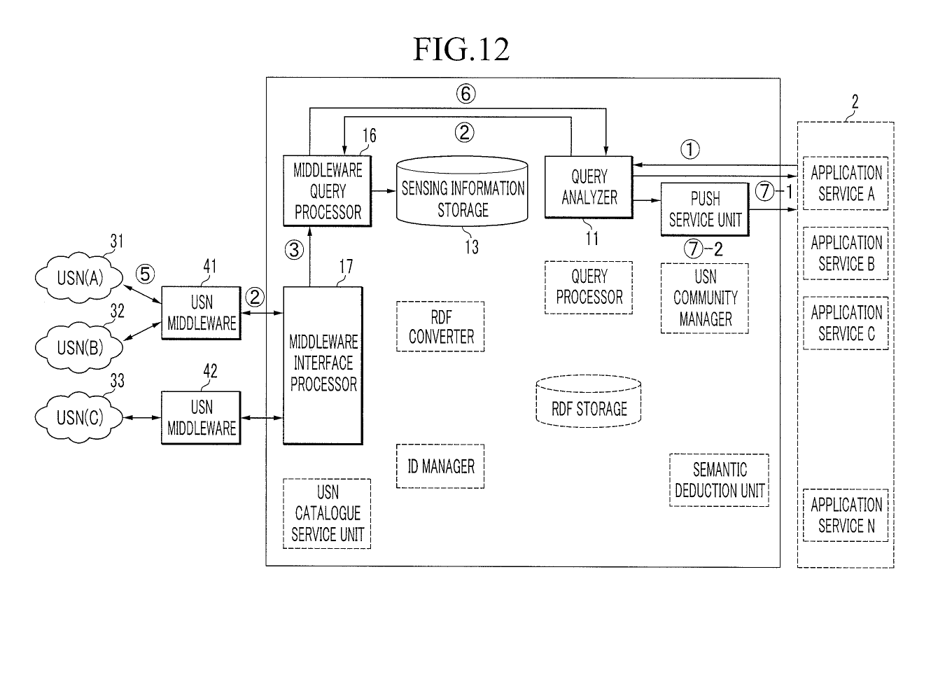

FIG. 11 is a flowchart showing the process of processing a real-time sensing value information query in the method for providing sensor network information according to an exemplary embodiment of the present invention, and FIG. 12 is a view showing the relationship between the components for the process of processing a real-time sensing value information query.

When a query occurs in an application service, the service equipment 2 transmits the query to the sensor network information provision apparatus 1, as shown in FIG. 11. The query analyzer 11 of the sensor network information provision apparatus 1 analyzes the input query (S400), and as shown in FIG. 12, if the query is a real-time sensing value information query, transmits the query to the middleware query processor 17.

The middleware query processor 17 generates a real-time middleware query in response to the input real-time sensing value information query, and transmits it to the middleware interface processor 17 (S410).

The middleware interface processor 17 passes the middleware query to the USN middleware (S420). Accordingly, the USN middleware requests responses from the USNs to the real-time middleware query, and receives responses to the request, i.e., real-time sensing values. The real-time sensing values from the USNs, responsive to the query, are transmitted to the middleware query processor 16 through the USN middleware and the middleware interface processor 17, as shown in FIG. 12 (S430).

The middleware query processor 16 transmits the real-time sensing values from the USNs to the query analyzer 11. If the type of the real-time sensing information query is a one-time query, the query analyzer 11 immediately transmits the real-time sensing values to the service equipment 2 (S440).

On the other hand, if the type of the real-time sensing value information query is a periodic sensing information query or event sensing information query, the sensing information is transmitted through the push service unit 15. In this case, the push service unit 15 pushes the sensing information according to a set cycle, or pushes the sensing information to the service equipment 2 if a predetermined event is satisfied.

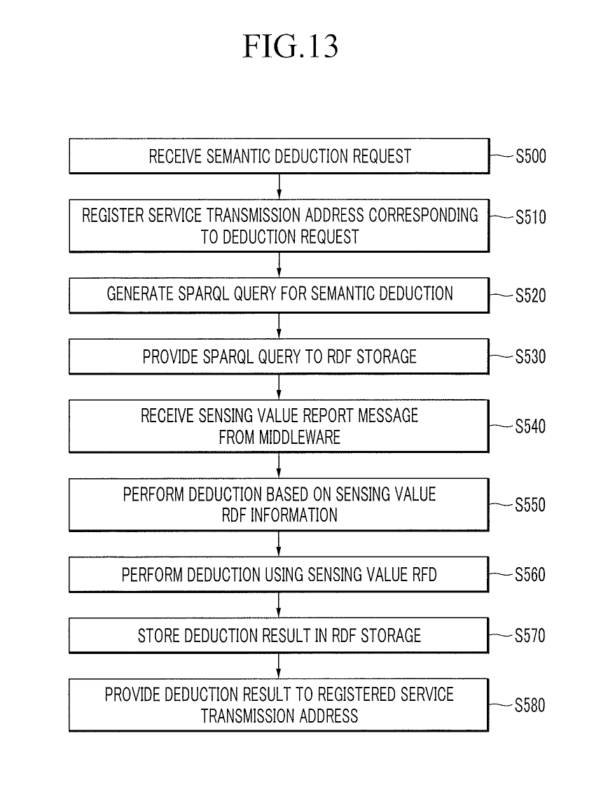

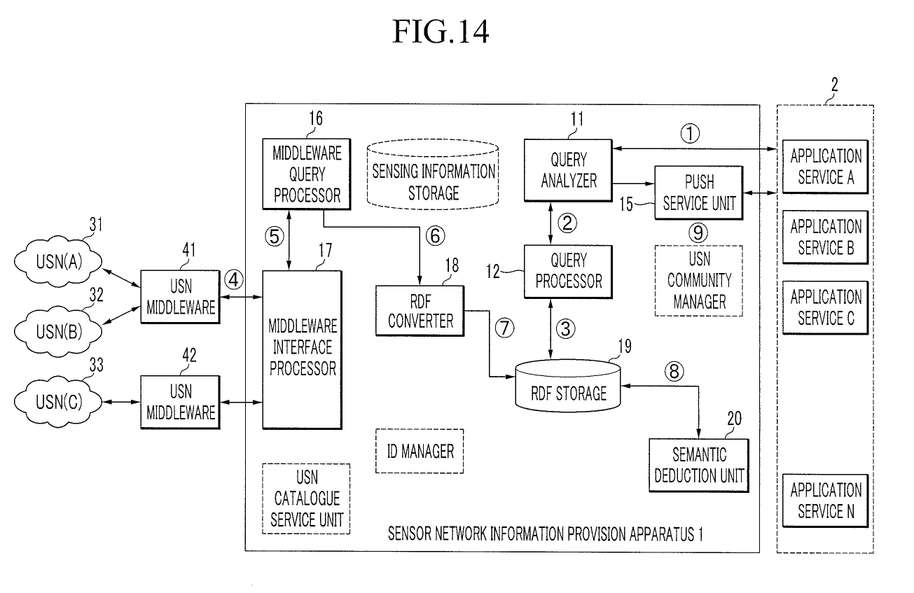

FIG. 13 is a flowchart showing the process of semantic USN deduction in the method for providing sensor network information according to an exemplary embodiment of the present invention, and FIG. 14 is a view showing the relationship between the components for the process of semantic USN deduction.

An application service may make a request for semantic deduction. Accordingly, the service equipment 2 transmits a semantic deduction request query to the sensor network information provision apparatus 1.

As shown in FIG. 13, when a semantic deduction request query is input, the query analyzer 11 receives a push service transmission address from the service equipment 2 and registers it (S500 and S510). Then, the query analyzer 11 generates a SPARQL query for semantic deduction and transmits it to the query processor 12 (S520). As shown in FIG. 14, the query processor 12 passes the semantic deduction query to the RDF storage 19 (S530).

The middleware interface processor 17 transmits a query request to the USN middleware 41 and 42 and receives a sensing information response, or receives a sensing information request by the above-described unidirectional sensing value reporting. The middleware interface processor 17 transmits a sensing value report message containing a query response (sensing value) to the middleware query processor 16 (S540).

The middleware query processor 16 passes the sensing value received from the USN middleware to the RDF converter 18, and the RDF converter 18 converts the sensing value into RDF and stores it in the RDF storage 19 (S550). Through the above-described steps S40 and S50 of obtaining sensing values, as shown in FIG. 14, sensing values are obtained from USNs and stored in the RDF storage 19.

The semantic deduction unit 20 performs deduction using the sensing value RDF information stored in the RDF storage 19, and stores a deduction result in the RDF storage 19 (S560 and S570). Such a semantic deduction result is asynchronously generated, and the query processor 12 transmits the semantic deduction result stored in the RDF storage 19 to the push service unit 15 to provide it to the service equipment 2 (S580). The push service unit 15 provides a semantic deduction result based on the push service transmission address registered in the step S510.

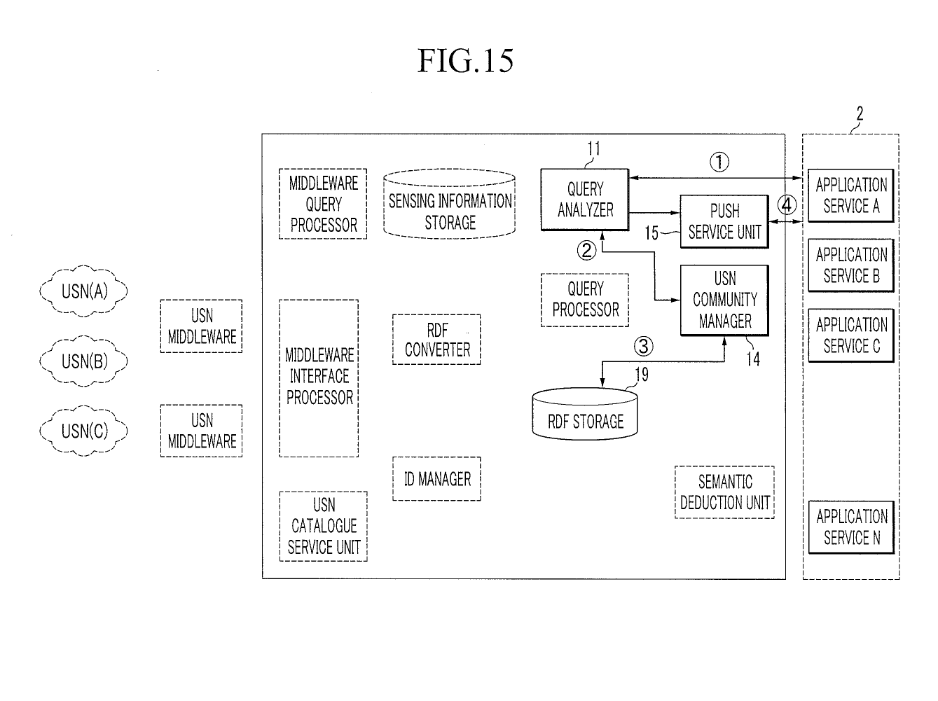

FIG. 15 is a view showing the relationship between the components for the process of creating and managing a USN community in the method for providing sensor network information according to an exemplary embodiment of the present invention.

When a query for requesting sensing values is received from the service equipment 2, the query analyzer 11 of the sensor network information provision apparatus 1 analyzes the query, and as shown in FIG. 15, if it is determined that the creation of a USN community is required, based on the analysis result of the query, requests the USN community manager 14 to create a USN community. In response to this request, the USN community manager 14 inquires for information stored in the RDF storage 19, and creates an appropraite USN community.

Once a USN community is created, the query analyzer 11 may make a query to request sensing values from the created USN community. This query may be processed in the same way as the above-described processes. The above-described non-real-time sensing value query, unidirectional sensing value reporting, real-time sensing value query, etc. may be performed on the newly created USN community.

According to an exemplary embodiment of the present invention, sensing information from various sensor network resources, which are built and managed in different formats, and information about the resources can be provided through semantic processing, which is a method of common information representation.

Accordingly, various services can share information about various sensor network resources and sensing information, and deduce different information and statuses by using this information. Moreover, by analyzing queries requested by various services, a query result containing sensing information of the quality required by the user and the services can be provided. Further, by offering a catalogue service that provides information about the allocation of IDs to USN resources, information about connections with the USN resources, operating state information of the USN resources, and so on, it is possible to cope with dynamic network connections and disconnections of the USN resources, and to support mobility of the USN resources.

The exemplary embodiments of the present invention may also be implemented by a program realizing functions corresponding to the construction of the embodiment, and a recording medium on which the program is recorded, other than the apparatus and/or method described above. Such implementation may be easily made from the disclosure of the above embodiments by those skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing sensor network information in an apparatus connected to sensor network middleware, the method comprising:
receiving sensing information containing sensing values obtained by sensor resources from the sensor network middleware;
converting the sensing information into an RDF (resource description framework) format and storing the same in an RDF storage;
analyzing a query provided from an application service; and
searching for information corresponding to the query, among the information stored in the RDF storage, based on the analysis result, and providing the same to the application service.

2. The method of claim 1, further comprising performing deduction based on the sensing information in the RDF format stored in the RDF storage.

3. The method of claim 2, wherein, in the providing of information to the application service, if the query is a semantic information query, a query result, which contains sensor resource metadata, sensing values, and deduced semantic information, is provided to the application service, based on the information in the RDF format stored in the storage.

4. The method of claim 1, further comprising:
storing the sensing information received from the sensor network middleware in a sensing information storage; and
if the query is a non-real-time sensing value information query based on the analysis result, providing the sensing information stored in the sensing information storage to the application service.

5. The method of claim 4, wherein
the providing of the sensing information stored in the sensing information storage to the application service comprises:
if the non-real-time sensing value information query is a one-time sensing information query, immediately providing the sensing information to the application service; and
if the non-real-time sensing value information query is an event sensing information query or a periodic sensing information query, providing the sensing information to the application service based on a pre-stored push service transmission address.

6. The method of claim 1, further comprising:
if the query is a real-time sensing value information query based on the analysis result, generating a middleware query corresponding to the query and transmitting the same to the sensor network middleware;
obtaining sensing information containing sensing values corresponding to the middleware query from the sensor network middleware; and
providing the obtained sensing information to the application.

7. The method of claim 1, further comprising, if it is determined that the creation of a sensor community is required, based on the analysis result, creating a new sensor community based on the information stored in the RDF storage.

8. The method of claim 1, further comprising:
receiving a request for ID allocation to the sensor resources from the sensor network middleware;
allocating IDs and URLs (uniform resource locators) to the sensor resources and transmitting the allocated information to the sensor network middleware;
receiving middleware connection information and sensor resource operating state information from the sensor network middleware; and
converting the allocated information, the connection information, and the operating state information into RDF, and storing and managing the same in the RDF storage.

9. An apparatus which is connected to sensor network middleware and providing sensor network information, the apparatus comprising:
a middleware interface processor that interfaces with the sensor network middleware;
a middleware query processor that receives sensing information containing sensing values obtained by sensor resources from the sensor network middleware;
an RDF converter that converts the sensing information into an RDF (resource description framework) form;
a storage that stores the sensing information in the RDF format;
a query analyzer that analyzes a query provided from an application service; and
a query processor that searches for information corresponding to the query, among the information stored in the RDF storage, based on the analysis result, and provides the same to the application service.

10. The apparatus of claim 9, further comprising a sensing information storage that stores the sensing information received from the sensor network middleware without RDF conversion.

11. The apparatus of claim 10, wherein
the query analyzer comprises:
a first query generator that, if the query is a semantic information query, generates a SPARQL (semantic protocol and RDF query language) query and transmits the same to the query processor;
a second query generator that, if the query is a non-real-time sensing value query, generates a query corresponding to the format of the sensing information storage, and transmits the same to the sensing information storage unit;
a third query generator that, if the query is a real-time sensing value query, generates a middleware query corresponding to the sensor network middleware; and
a fourth query generator that, if the query is a community- related query, generates a community sensing value query request if it is determined that a continuous query for sensing values for a specific sensor community is required, based on the analysis result.

12. The apparatus of claim 11, further comprising a middleware query processor that transmits the middleware query to the sensor network middleware involved through the middleware interface processor, receives response values from the sensor network middleware in response to the middleware query, and provides the same to the query analyzer, provides the same in the sensing information storage unit, or provides the same to the RDF converter.

13. The apparatus of claim 11, further comprising a community manager that generates a new sensor community based on the information stored in the RDF storage if it is determined that the creation of a sensor community is required, based on the analysis result.

14. The apparatus of claim 11, wherein, for a semantic information query, the query analyzer provides a query result, which contains sensor resource metadata, sensing values, and deduced semantic information, to the application service, based on the information in the RDF format stored in the RDF storage.

15. The apparatus of claim 9, further comprising a semantic deduction unit that performs deduction based on the sensing information in the RDF format stored in the RDF storage, and stores semantic information corresponding to the deduction result in the RDF storage.

16. The apparatus of claim 9, further comprising a push service unit that, if the non-real-time sensing value information query is an event sensing information query or periodic sensing information query, provides the sensing information to the application service based on a pre-stored push service transmission address.

17. The apparatus of claim 9, further comprising:
an IP manager that allocates IDs and URLs (uniform resource locators) to the sensor resources in response to an ID allocation request from the sensor network middleware, and converts the allocated information into RDF format by the RDF converter and stores and manages the same in the RDF storage; and
a catalogue service unit that receives middleware connection information and sensor resource operating state information from the sensor network middleware, and converts the allocated information, the connection information, and the operating state information into RDF, and stores and manages the same in the RDF storage.
